(19) United States
(12) Patent Application Publication
(10) Pub. No.: US 2016/0041769 A1
(43) Pub. Date: Feb. 11, 2016

(54) RECORDING MEDIUM STORING ACCESS CONTROL PROGRAM, ACCESS CONTROL APPARATUS, AND ACCESS CONTROL METHOD

(71) Applicant: FUJITSU LIMITED, Kawasaki (JP)

(72) Inventors: Hidekazu TAKAHASHI, Kawasaki (JP); Miho Murata, Kawasaki (JP); Kazutaka OGIHARA, Hachioji (JP); Motoyuki Kawaba, Kawasaki, Japan (JP)

(73) Assignee: FUJITSU LIMITED, Kawasaki (JP)

(21) Appl. No.: 14/817,454

(22) Filed: Aug. 4, 2015

(30) Foreign Application Priority Data
Aug. 7, 2014 (JP) 2014-161698
Jun. 25, 2015 (JP) 2015-128148

(51) Int. Cl. G06F 3/06

(52) U.S. Cl. CPC G06F 3/0608; G06F 3/064; G06F 3/0652; G06F 3/0674

(57) ABSTRACT

An access control apparatus includes a processor that executes a process including: reading first consecutive blocks from a storage device in response to an access request for a first data, the first consecutive blocks including a first block, storage areas of the storage device being managed in units of blocks; loading the first consecutive blocks into a memory area, storage areas of the memory area being managed in units of pages; and in accordance with a state of an access to a page in the memory area, invalidating a specific block of the storage device that corresponds to a specific page pushed out of the memory area, the specific page being pushed out as a consequence of loading the first consecutive blocks into the memory area, and writing second data included in the specific page to consecutive empty areas of the storage device.

### CROSS-REFERENCE TO RELATED APPLICATION

This application is based upon and claims the benefit of priority of the prior Japanese Patent Application No. 2014-161698, filed on Aug. 7, 2014 and the Japanese Patent Application No. 2015-128148, filed on Jun. 25, 2015, the entire contents of which are incorporated herein by reference.

### FIELD

The embodiment discussed herein is related to a technique for accessing data stored in a storage device.

### BACKGROUND

With the recent speeding up of business, there has been demand for processing a large amount of data that flows successively in real time. Because of this demand, attention has focused on a stream data process, which is a technique of executing an analysis process for flowing data on site.

Stream processes include a process that recognizes, as an analysis target, data having a size larger than that storable in a memory. To process the data having a size larger than that storable in a memory, a disk is accessed in accordance with a process, and an analysis process is executed.

Patent Document 1: Japanese Laid-open Patent Publication No. HEI10-31559

Patent Document 2: Japanese Laid-open Patent Publication No. 2008-16024

Patent Document 3: Japanese Laid-open Patent Publication No. 2008-204041

### SUMMARY

A non-transitory computer-readable recording medium having stored therein a program for causing a computer to execute a distribution process according to one aspect of the present invention causes the computer to execute the following process. The computer reads first consecutive blocks from a storage device in response to an access request for a first data, the first consecutive blocks including a first block, storage areas of the storage device being managed in units of blocks. The computer loads the first consecutive blocks into a memory area, storage areas of the memory area being managed in units of pages. The computer invalidates, in accordance with a state of an access to a page in the memory area, a specific block of the storage device that corresponds to a specific page pushed out of the memory area, the specific page being pushed out as a consequence of loading the first consecutive blocks into the memory area. The computer writes second data included in the specific page to consecutive empty areas of the storage device.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is an explanatory diagram of handling data blocks between a memory area and a disk in data accesses.

FIG. 2 is an explanatory diagram of prefetches performed in data accesses.

FIG. 3A is an explanatory diagram (No. 1) of a phenomenon that can occur in a case where disk accesses frequently occur.

FIG. 3B is an explanatory diagram (No. 2) of a phenomenon that can occur in a case where disk accesses frequently occur.

FIG. 4 illustrates an example of an access control apparatus according to an embodiment.

FIG. 5A is an explanatory diagram (No. 1) of operations performed in the embodiment.

FIG. 5B is an explanatory diagram (No. 2) of operations performed in the embodiment.

FIG. 5C is an explanatory diagram (No. 3) of operations performed in the embodiment.

FIG. 6 is an explanatory diagram of a filling rate in the embodiment.

FIGS. 7A and 7B are explanatory diagrams of data and blocks in the embodiment.

FIG. 8 illustrates a hardware configuration of a server in the embodiment.

FIG. 9 illustrates an example of physical layout management information in the embodiment.

FIG. 10 illustrates an example of a page management list in the embodiment.

FIG. 11 illustrates an operational flow of an I/O execution unit in the embodiment.

FIG. 12 illustrates an operational flow of IF getitems_bulk(K,N) in the embodiment.

FIG. 13 illustrates an operational flow of an IO size calculation unit in the embodiment.

FIG. 14 illustrates an example of an update of a page management list when a block having a block Id (K=7) is requested in the embodiment.

FIG. 15 illustrates an example of an update of a page management list after getitems_bulk(K,N) is called in the embodiment.

FIG. 16 illustrates an operational flow of a page management unit in the embodiment.

FIG. 17A illustrates an operational flow (No. 1) of IF setitems_bulk(N) in the embodiment.

FIG. 17B illustrates an operational flow (No. 2) of the IF setitems_bulk(N) in the embodiment.

FIG. 17C illustrates an operational flow (No. 3) of the IF setitems_bulk(N) in the embodiment.

FIG. 18 is an explanatory diagram of a case where blocks corresponding to pages indicated by four entries sequentially from the bottom of the page management list are selected as target blocks in the embodiment.

FIG. 19 is an explanatory diagram of an example where entries of blocks are extracted from physical layout management information in the embodiment.

FIG. 20 illustrates an example of an update of the physical layout management information in the embodiment.

FIG. 21 is an explanatory diagram of an example where entries of pages corresponding to target blocks are deleted from the page management list in the embodiment.

FIG. 22 illustrates an example of a configuration block diagram of a hardware environment of a computer that executes a program according to the embodiment.

### DESCRIPTION OF EMBODIMENT

To make a data access efficient, a server can preread, into a memory area, blocks physically laid out in the neighborhood of a block requested with a data access by expecting that the blocks physically laid out in the neighborhood are accessed along with the block, requested with the data access, of a disk.

However, the blocks physically laid out in the neighborhood of the requested block are accessed when the layout of blocks on the disk and the data access are related to each other. When the layout of the blocks on the disk and the data access are not sufficiently related to each other, the blocks laid out in the neighborhood of the block for which the access request is issued are not actually accessed even though they are pre-read, whereby the use efficiency of the memory area is degraded.

One aspect of an embodiment provides a technique for improving the use efficiency of read blocks in a data access using a process for reading also neighboring blocks along with a requested block from a storage device.

In a stream process handling data having a size larger than that storable in a memory, disk accesses frequently occur when a large amount of data inflows, so that this affects the throughput of the entire server.

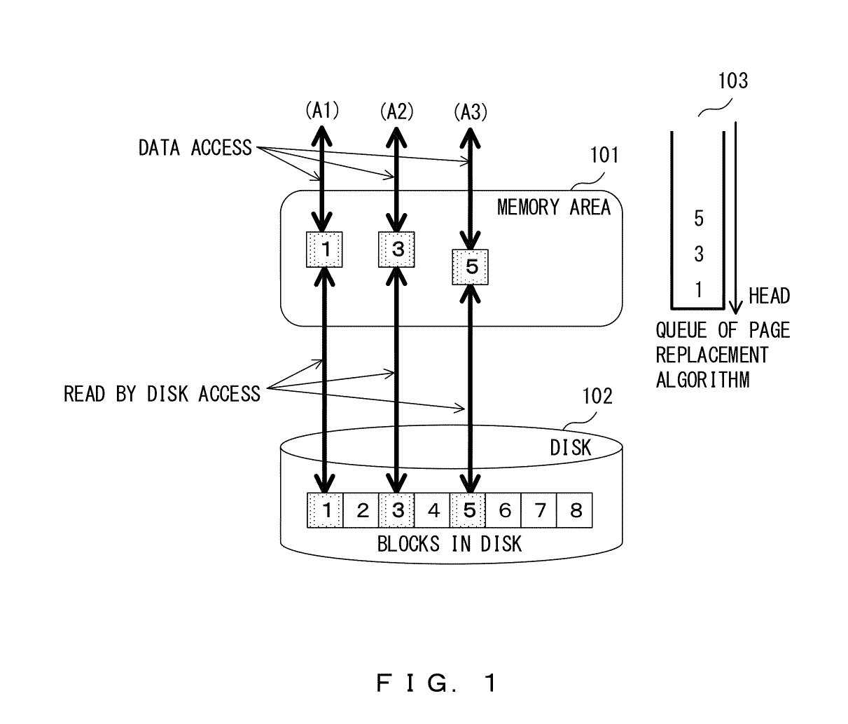

FIG. 1 is an explanatory diagram of handling blocks between a memory area and a disk in data accesses. In FIG. 1, a disk 102 and a memory area 101 are depicted. Here, a partial area of a memory is depicted as the memory area 101. As an algorithm for replacing a page (page replacement algorithm) in a memory area, for example, a method (Least Recently Used: LRU) that recognizes, as a replacement target, a page that has not been referenced for the longest time in the memory area 101 is used.

In FIG. 1, a plurality of blocks 1 to 8 are laid out in the disk 102. Blocks in which data are requested by a data access request are read and laid out in the memory area 101. When the data access request is issued to read, for example, the data stored in the blocks 1, 3 and 5, these blocks are read from the disk 102, and pages 1, 3 and 5 corresponding to the read blocks 1, 3 and 5 are laid out in the memory area 101.

Here, when a page laid out in the memory area 101 is replaced, a page to be replaced (replacement page) is decided with a page replacement algorithm.

With the LRU method, a page that is held in the memory area 101 and has the oldest access date and time is selected as a replacement page. A block corresponding to the replacement page is rewritten, for example, to the disk 102. Pages are managed by a queue 103 in chronological order of date and time of an access to the pages. For example, a page corresponding to accessed data is laid out at the end of the queue 103. As a result, a page corresponding to data that is not accessed is positioned closer to the head of the queue 103. Pages to be replaced are selected sequentially from a page positioned at the head of the queue 103, and data within the selected pages are rewritten, for example, to the disk 102. In FIG. 1, the queue 103 represents the state of the queue after data accesses have occurred in the order of (A1), (A2) and (A3).

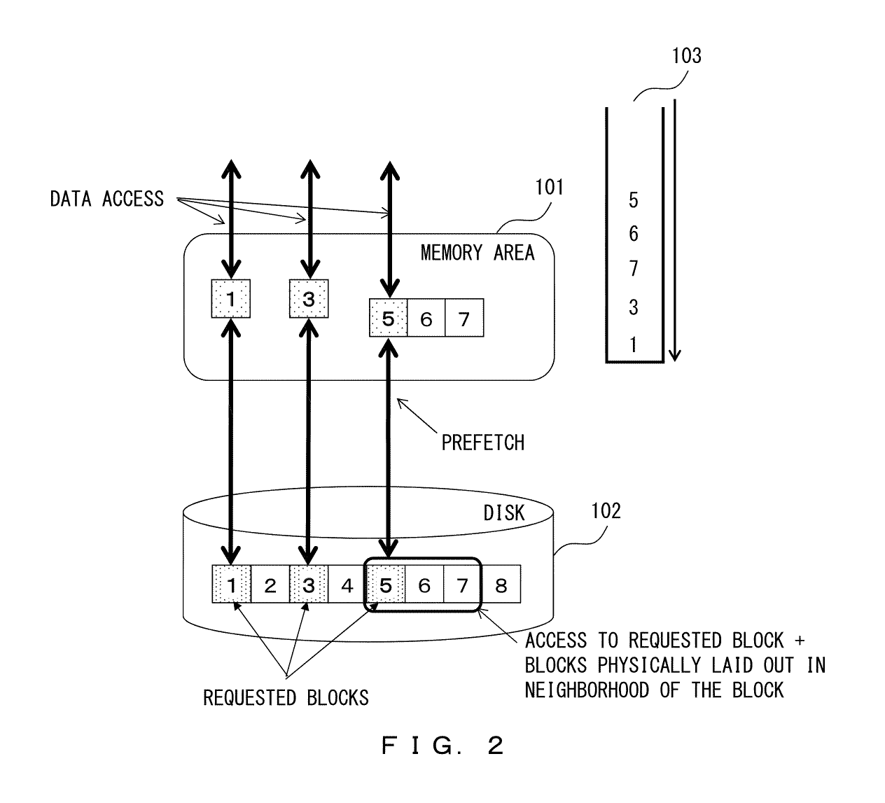

FIG. 2 is an explanatory diagram of prefetches performed in data accesses. In this embodiment, a prefetch is a pre-read of blocks that are physically laid out in the neighborhood of a block requested to be accessed in the disk 102 into a memory area 101.

FIG. 2 illustrates a state where a page corresponding to a block (5) requested by a data access request is laid out in the memory area 101. Namely, FIG. 2 represents that pages (5, 6, 7) in the memory area 101 are laid out by also accessing blocks (6, 7) that are physically laid out in the neighborhood of the requested block (5) in the disk when the page is laid out in the memory area.

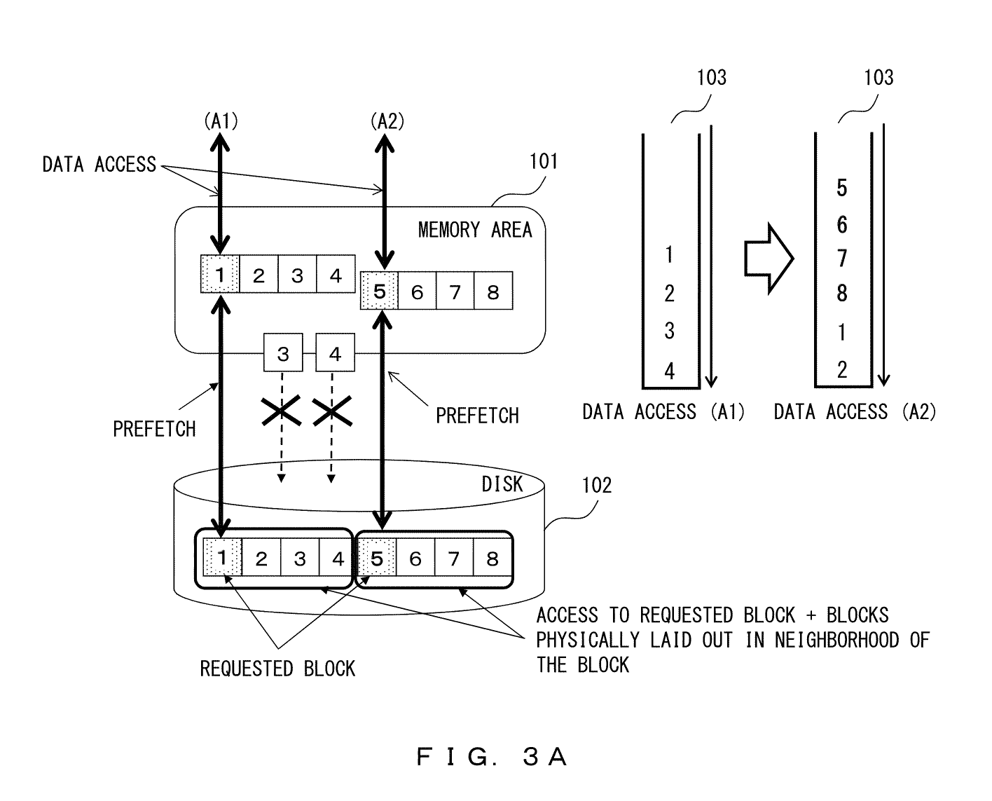

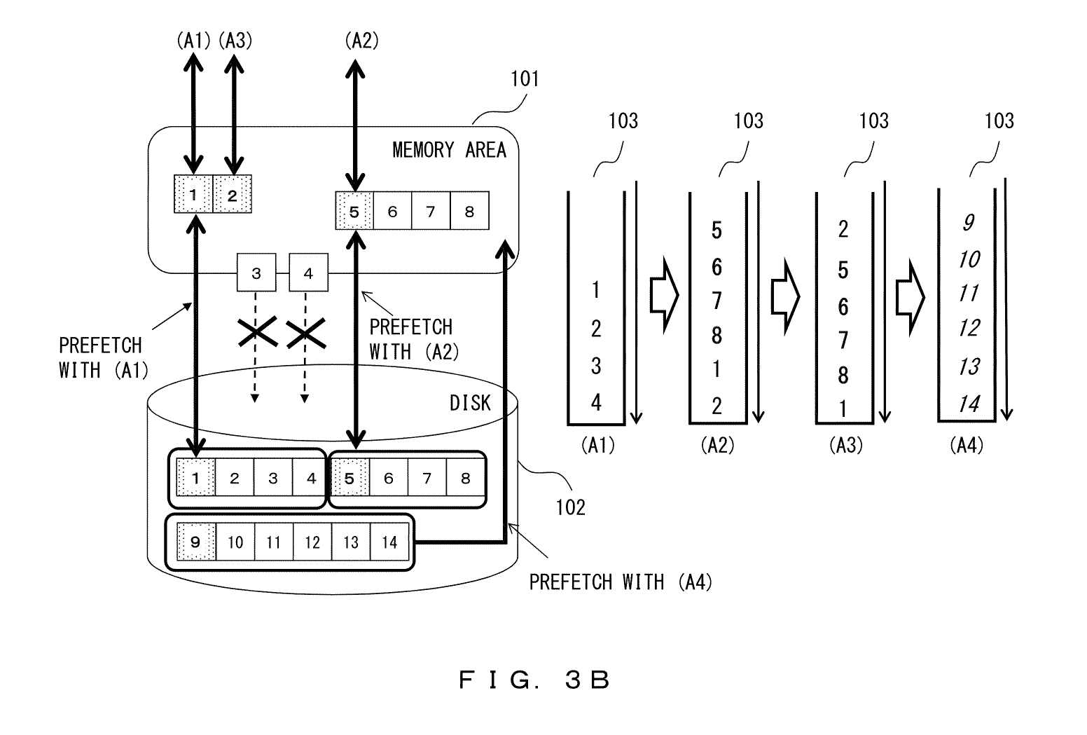

FIGS. 3A and 3B are explanatory diagrams of a phenomenon that can occur when disk accesses frequently occur. In a situation where disk accesses frequently occur, data is frequently rewritten from the memory area 101 to the disk 102 by the page replacement algorithm due to a restriction placed on the size of the memory area 101.

In FIG. 3A, when a block 1 and blocks (2, 3, 4) in the neighborhood of the block 1 in the disk 102 are accessed by a prefetch of a data access (A1), the pages 1, 2, 3 and 4 are laid out in the memory area 101.

When the block 5 and the blocks (6, 7, 8) in the neighborhood of the block 5 in the disk 102 are accessed by a prefetch of a data access (A2), the pages 5, 6, 7 and 8 are laid out in the memory area 101. In this case, the pages are replaced with the page replacement algorithm due to the restriction placed on the size of the memory area 101 (assumed to be six pages). As a result, the pages 3 and 4 corresponding to the blocks 3 and 4 pre-read with the data access (A1) are not accessed. Therefore, they are regarded as replacement targets.

When the number of pages that are pre-read and replaced without being accessed increases among pages (pages that are pre-read from the disk before an access request and laid out in the memory), a ratio of pages that are not accessed and occupy the memory area 101 increases. As a result, the use efficiency of the memory area is degraded. Moreover, when the number of pages that are replaced without being accessed increases among the pages pre-read with a prefetch, a ratio of blocks that are accessed among the plurality of blocks pre-read with the prefetch is reduced, so that a disk access also becomes inefficient.

For example, a case where the data accesses (A1) to (A4) are performed as illustrated in FIG. 3B is described. With the data accesses (A1), (A2) and (A4), a prefetch is performed.

Accessed pages among the pages 1, 2, 3, and 4 corresponding to the blocks prefetched with the data access (A1) are the pages 1 and 2, and a ratio of the used pages is 2/4. In the meantime, an accessed page among the pages 5, 6, 7 and 8 corresponding to the blocks prefetched with the data access (A2) is the page 5, and a ratio of the accessed page is 1/4.

Accordingly, this embodiment refers to a technique for reducing the number of useless reads performed with a prefetch by laying out blocks in a storage device in accordance with whether a page corresponding to a block prefetched from the storage device is used in a memory area, and for improving the use efficiency of the memory area.

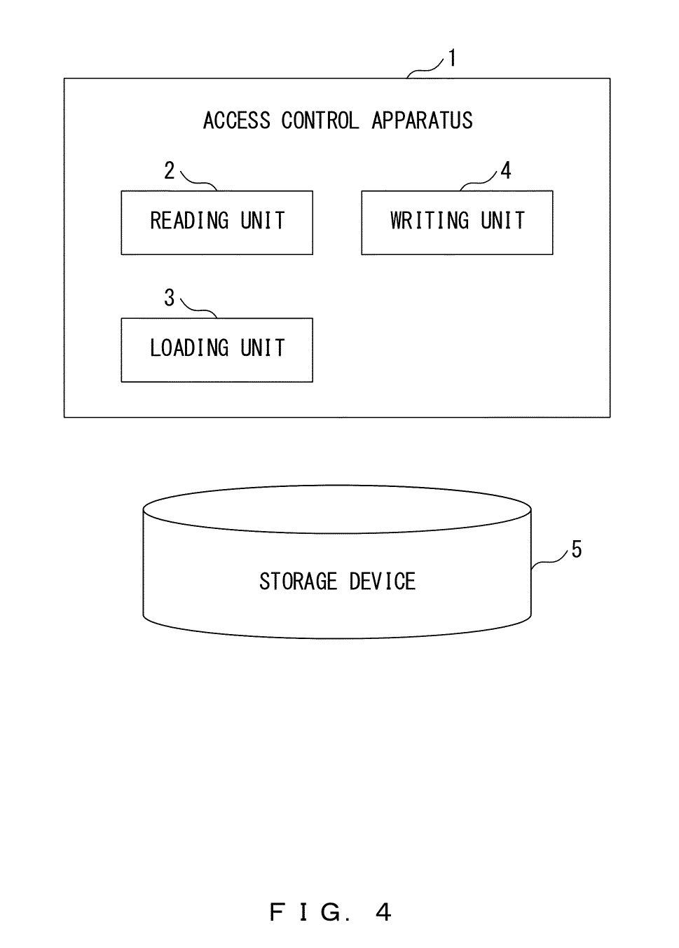

FIG. 4 illustrates an example of an access control apparatus according to this embodiment. The access control apparatus 1 includes a reading unit 2, a loading unit 3, and a writing unit 4. As one example of the access control apparatus 1, the control unit 12 is cited.

The reading unit 2 reads first consecutive blocks from a storage device in response to an access request for a first data. The first consecutive blocks include a first block. Storage areas of the storage device are managed in units of blocks. As one example of the reading unit 2, the I/O execution unit 13 is cited.

The loading unit 3 loads the first consecutive blocks into a memory area. Storage areas of the memory area are managed in units of pages. As one example of the loading unit 3, the I/O execution unit 13 is cited.

The writing unit 4 invalidates in accordance with a state of an access to a page in the memory area, a specific block of the storage device that corresponds to a specific page pushed out of the memory area. The specific page is pushed out as a consequence of loading the first consecutive blocks into the memory area. At the same time, the writing unit 4 writes second data included in the specific page to consecutive empty areas of the storage device. As one example of the writing unit 4, the page management unit 17 is cited.

With this configuration, a block can be laid out in the storage device 5 in accordance with whether a page corresponding to the block prefetched from the storage device 5 is used in a memory area.

The writing unit 4 invalidates the specific block of the storage device that corresponds to the specific page accessed in the memory area from among one or more pushed-out pages. With this configuration, a block in the storage device that corresponds to a page can be invalidated and added when the page accessed in the memory area is rewritten to the storage device 5. As a result, consecutively empty areas in a physical area of the storage device can be secured, and at the same time, blocks corresponding to accessed pages can be laid out collectively in the physical area of the storage device.

The reading unit 2 reads the first consecutive blocks by using one of a first read method and a second read method. The first read method is a method for reading the first consecutive blocks from the storage device 5 and loading the first consecutive blocks into the memory area. The second read method is a method for executing the first read method and invalidating the first consecutive blocks of the storage device 5. At this time, the writing unit 4 writes third data, which is a page not accessed in the memory area and is the pushed-out page that corresponds to the invalidated specific block, to the empty areas along with the second data, when the second data is the specific page accessed in the memory area.

With this configuration, data that is not accessed among data read into the memory area with the second read method can be added to the storage device along with the data accessed in the memory area.

The reading unit 2 selects one of the first read method and the second read method in accordance with a ratio of valid blocks to the first consecutive blocks.

With this configuration, the read method is selected in accordance with the ratio of valid blocks among blocks to be prefetched, whereby invalid areas caused by repeatedly deleting and adding an accessed block can be prevented from being scattered.

This embodiment is described in detail below.

This embodiment is executed, for example, by a control unit that implements a storage middleware function in a server device (hereinafter referred to as a “server”). When the server reads a block from the disk, it reads (prefetches) valid blocks that are physically laid out in the neighborhood of a requested block in addition to the block requested by a data access request issued from an application program (hereinafter referred to as an “application”).

In this read, the server selects and executes, as a read method, either of a volatile read (a read block is deleted (invalidated) from the disk 102) and a nonvolatile read (a read block is not deleted from the disk 102). The read method is selected on the basis of a ratio (filling rate) of “valid” blocks among a plurality of blocks read from the disk 102 with a prefetch. The server normally reads blocks with the nonvolatile read. However, when a value of a filling rate becomes smaller than a threshold value, the server reads blocks with the volatile read.

The server writes pages to the disk by designating the pages separately as a “used page (namely, an accessed page) and an “unused page (namely, a page that is not accessed) in two lists. Here, when “used pages” are rewritten to the disk 102, the server invalidates blocks that were previously read from the disk 102 and that correspond to the pages, and collectively adds the blocks corresponding to the pages to the physical area of the disk 102. In this way, blocks corresponding to used pages can be laid out collectively in the disk 102, whereby the number of useless reads can be reduced and the use efficiency of the memory area can be improved.

When “unused pages” are read with the nonvolatile read, the server performs no operations. In contrast, when “unused pages” are read with the volatile read, the server adds the unused pages to the physical area of the disk 102 along with a used page . The volatile read is performed, so that a plurality of blocks prefetched with the volatile read can be deleted from the physical area of the disk 102. As a result, consecutively empty areas can be secured in the physical area.

When a block corresponding to a “used page” is repeatedly added to the disk 102, invalid areas will scatter in the physical area of the disk 102. Accordingly, it becomes difficult to secure consecutively empty areas. As a result, when pages are rewritten collectively to the disk, a needed number of consecutively empty areas cannot be secured in some cases. In this case, to prevent invalid areas from being scattered in the disk 102 without rearranging the blocks, the volatile read is performed when the filling rate becomes lower than a threshold value. As a result, the consecutively empty areas can be secured.

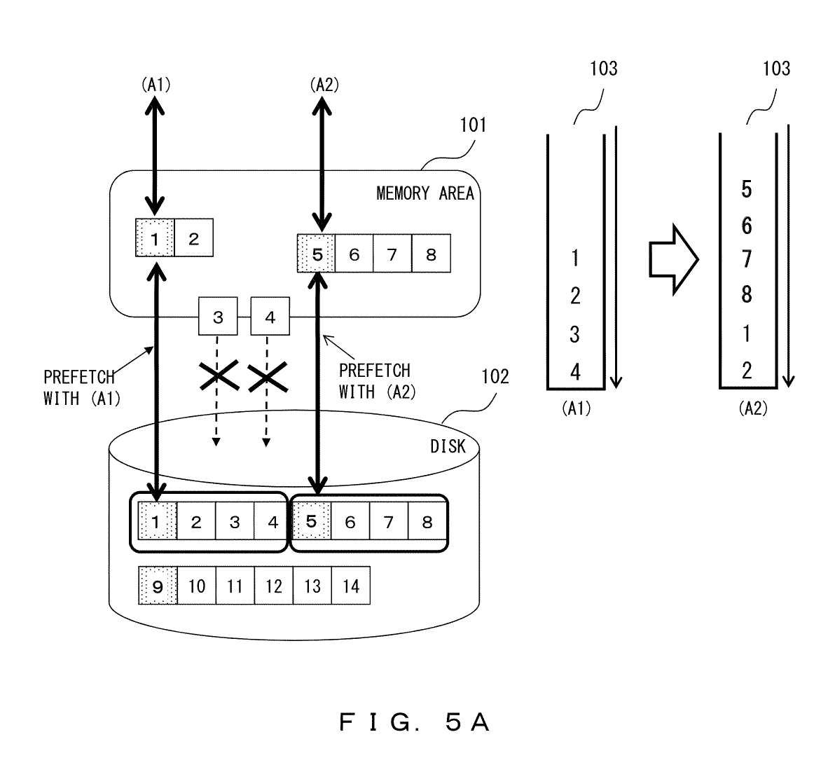

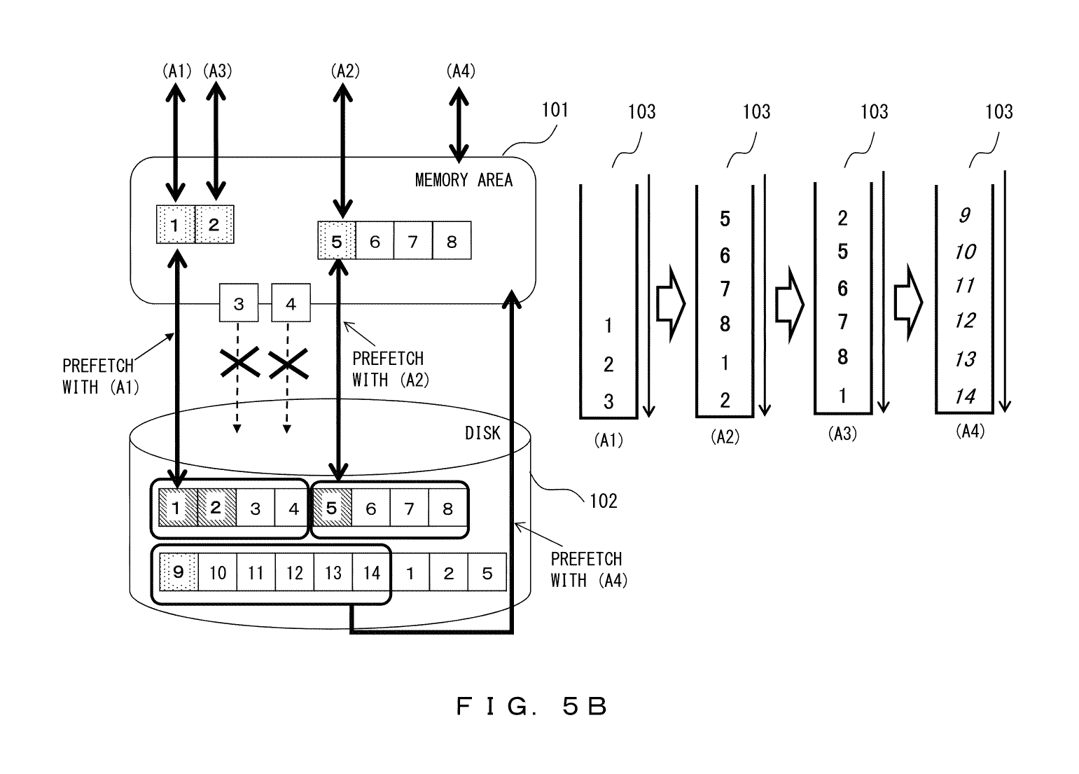

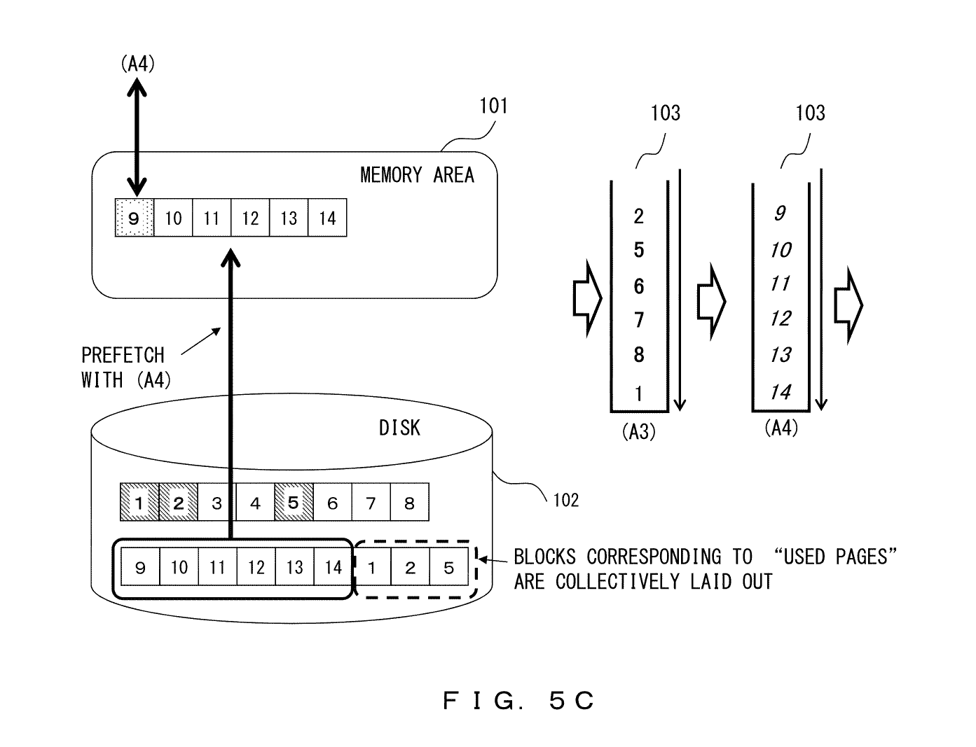

FIGS. 5A to 5C are explanatory diagrams of operations performed in this embodiment. In this embodiment, the LRU method is used as one example of the page replacement algorithm. Moreover, the restriction placed on the size of the memory area 101 is assumed to be six blocks.

As illustrated in FIG. 5A, “unused pages” among pages read with the nonvolatile read are not rewritten to the disk 102.

In FIG. 5A, in the data access (A1), the (block 1) and the blocks (2, 3, 4) in the neighborhood of the block (1) are accessed with the nonvolatile read. In the data access (A2), the block (5) and the blocks (6, 7, 8) in the neighborhood of the block (5) are accessed with the nonvolatile read.

The pages 3 and 4 stored in the memory area 101 are “unused pages”, and read with the nonvolatile read. Therefore, the pages 3 and 4 are not rewritten to the disk 102.

As illustrated in FIG. 5B, when a “used page” is rewritten to the disk 102, a block at a read source of the page in the disk 102 is invalidated and added to an area next to the last existing valid block.

Assume that the data access (A4) is performed after the data accesses (A1, A2, A3) are performed in FIG. 5B. In the data access (A4), a block (9) and blocks (10 to 14) in the neighborhood of the block (9) are read with a prefetch.

At this time, all the pages in the memory area 101 are rewritten to the disk 102 due to the restriction placed on the size of the memory area 101. Pages corresponding to the blocks (1, 2, 5) are “used pages”. Therefore, the existing corresponding blocks (1, 2, 5) in the disk 102 are invalidated and added to the end of the area used in the disk 102 when the pages are rewritten to the disk 102. As illustrated in FIG. 5C, the blocks corresponding to the “used pages” are collectively laid out at the end of the area used in the disk 102.

By adding blocks in an area of the disk 102 in this way, blocks corresponding to “used pages” are collectively laid out. As a result, the number of useless reads can be reduced, and the use efficiency of the memory area can be improved.

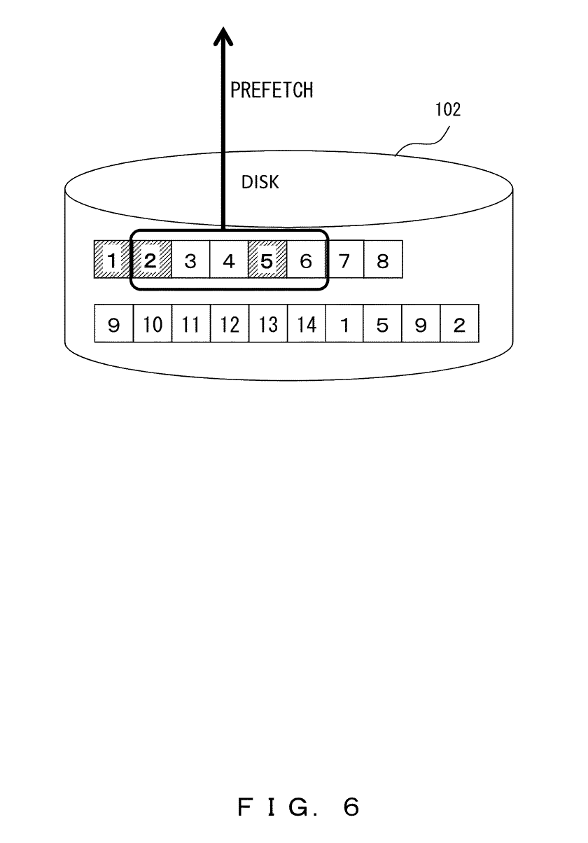

FIG. 6 is an explanatory diagram of the filling rate in this embodiment. The filling ratio is a ratio of valid blocks among read blocks when the blocks in the disk 102 are read.

In FIG. 6, the number of blocks read with a prefetch is five. Valid blocks among the read blocks are three blocks (3, 4, 6). In this case, the filling rate=3/5=60 percent. Accordingly, when the number of invalid blocks increases among the read blocks, the filling rate is reduced.

A state of each block that is valid or invalid is held, for example, in layout management information, which will be described later, about all the blocks. A method for holding the state of a block is not limited to this one.

As described above, a used block is added to the end of a used area after the existing corresponding block is invalidated. When this operation is repeatedly performed, invalid blocks will scatter in the disk 102. Therefore, it becomes difficult to secure a collective area in the disk 102. Therefore, when the value of the filling rate is smaller than a threshold value, the volatile read is performed.

According to this embodiment, “used blocks” are collectively laid out in an area of a disk. As a result, the number of useless reads performed with a prefetch can be reduced, and the use efficiency of the memory area can be improved. Namely, a prefetch can be made efficient, and at the same time, a speeding up can be achieved by efficiently using the memory area.

This embodiment is further described in detail below.

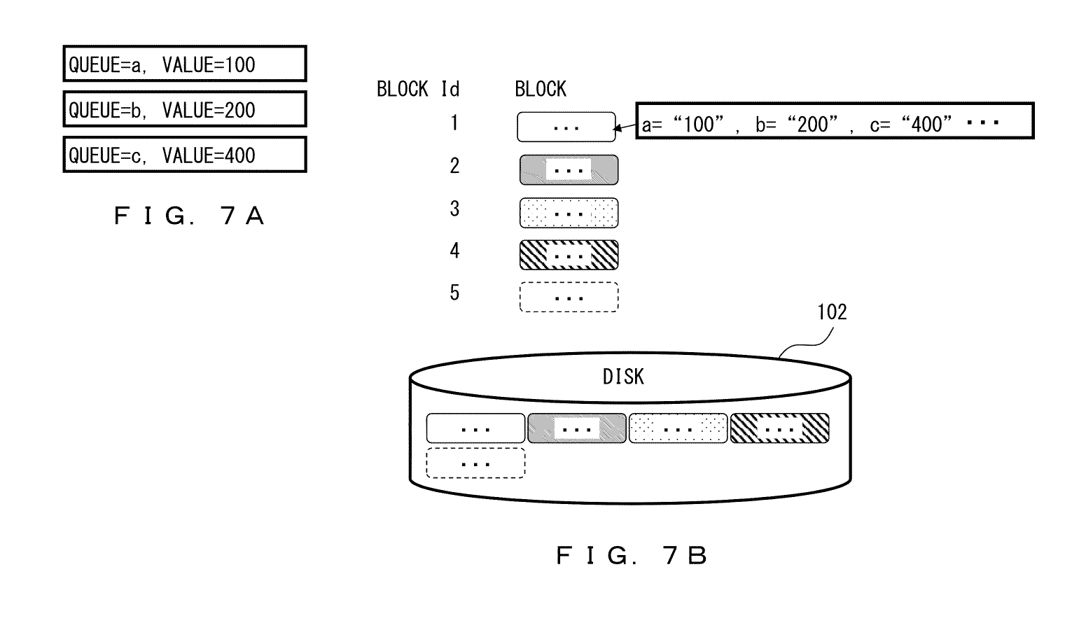

FIGS. 7A and 7B are explanatory diagrams of data and blocks in this embodiment. The data is a pair of a key and a value as illustrated in FIG. 7A. A block is the unit of management, and is managed with an address in the disk 102. The data is stored in units of blocks in the disk 102 as illustrated in FIG. 7B. Each block includes a plurality of pairs of data.

A block and a page corresponding to the block are identified with a block Id. A block is read by designating a block Id.

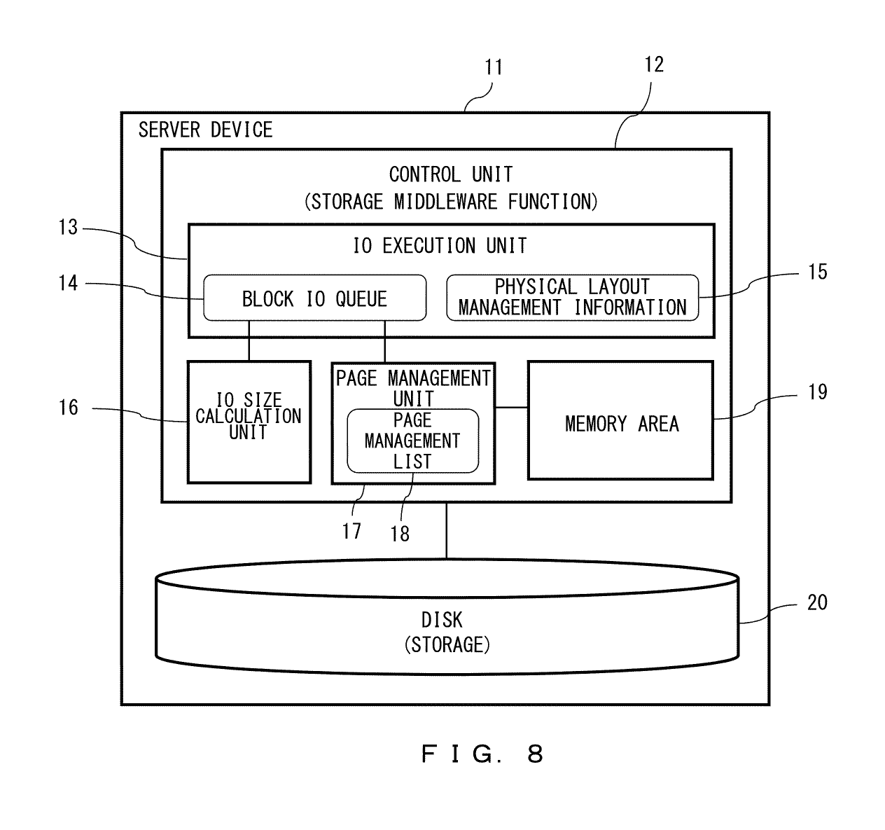

FIG. 8 illustrates a hardware configuration of the server in this embodiment. The server 11 includes a control unit 12 and a disk (storage) 20. The control unit 12 has a storage middleware function of writing and reading a block to and from the disk 20 by reading a program according to this embodiment from a storage device (not illustrated) and executing the program.

Examples of input and output (IO) interfaces (IF) of the storage middleware include “getitems_bulk(K,N)”, and “setitems_bulk(N)”.

“getitems_bulk(K,N)” is an IF with which the control unit 12 reads a block from the disk 20 into a memory area. K is a block Id of a target requested to be read. The control unit 12 collectively reads (prefetches) a block corresponding to the key K and blocks that are physically laid out in the neighborhood of the block in the disk. N is an IO size to be described later. The IO size indicates a neighboring range (a size or the number of pieces of data may be available) of a physical layout to be accessed, and a neighboring area indicated by a designated range is accessed. In this embodiment, the IO size (N) is designated with the number of blocks.

“setitems_bulk (N)” is an IF with which the control unit 12 writes blocks to the disk 20. The control unit 12 designates an IO size(N). With “setitems_bulk”, a block to be written is determined on the basis of the IO size (N).

The control unit 12 includes the I/O execution unit 13, the IO size calculation unit 16, the page management unit 17, and the memory area 19.

The I/O execution unit 13 performs a block read that accesses a block in the disk 20 in response to a data access (read access or write access) request issued from an application.

The I/O execution unit 13 has a block IO queue 14 and physical layout management information 15. The block IO queue 14 is a queue in which an Id of a requested block is inserted. The physical layout management information 15 manages validity/invalidity and a block address of each block in the disk 20.

The I/O execution unit 13 reads a block by executing “getitems_bulk (K,N). When an access request to a block is issued from an application, the I/O execution unit 13 puts a block Id of the requested block in the block IO queue 14, sequentially extracts block Ids from the block IO queue 14, and executes requests.

At that time, the I/O execution unit 13 calls the IO size calculation unit 16 to obtain the number (N) of blocks to be read. Nis a value greater than or equal to one and the value that the IO size calculation unit 16 decides in accordance with the length (L) of the block IO queue 14 and an IO size (N′) calculated in response to a preceding block read request.

When the I/O execution unit 13 reads a block, it extracts a block Id from the head of the block IO queue 14, obtains a block address through the physical layout management information 15, and accesses the disk 20 on the basis of the block address.

At this time, the I/O execution unit 13 accesses a a block corresponding to the designated block Id (K). At the same time, the I/O execution unit 13 accesses blocks in the neighborhood of the block in the physical layout on the disk 20 in accordance with the number designated with N, and returns a block valid in the physical layout management information among the accessed blocks.

When the I/O execution unit 13 reads blocks, it normally uses the nonvolatile read, or uses the volatile read in a case where the value of the filling rate is smaller than a certain threshold value.

The I/O execution unit 13 references the physical layout management information 15 before it reads blocks, calculates a filling rate, and selects either of the volatile read and the nonvolatile read as a read method on the basis of the filling rate.

The I/O execution unit 13 invalidates a block in the physical layout management information 15 when it deletes the block in the case where the I/O execution unit 13 selects the volatile read.

Additionally, the I/O execution unit 13 rewrites, to the disk 20, blocks by a number designated with N among blocks corresponding to pages stored in the memory area 19 by executing “setitems_bulk(N)”. At this time, the I/O execution unit 13 classifies the blocks corresponding to the pages stored in the memory area 19 into a used block [used_key_value_list] and an unused block [unused_key_value_list] in accordance with information of a reference counter, which will be described later, of the page management list 18.

For the block designated with [unused_key_value_list], the I/O execution unit 13 references the physical layout management information 15 before it writes the block to the disk 20, and verifies whether the block has been read either with the volatile read or with the nonvolatile read. Namely, the I/O execution unit 13 references the physical layout management information 15, and verifies whether the block has been read either with the volatile read or with the nonvolatile read depending on whether the block is invalid.

The I/O execution unit 13 performs no operations when the block designated with [unused_key_value_list] has been read with the nonvolatile read. When the block designated with [unused_key_value_list] has been read with the volatile read, the I/O execution unit 13 decides the block as a target to be added to the disk 20.

The I/O execution unit 13 invalidates an existing corresponding block for the block designated with [used_key_value_list], and decides the block as a target to be added to the disk 20.

When the block to be added to the disk 20 is decided, the I/O execution unit 13 updates the physical layout management information 15, and adds the decided target block to the disk 20. Regardless of the target to be added, the I/O execution unit 13 deletes blocks designated with [unused_key_value_list] and [used_key_value_list] from the page management list 18.

The IO size calculation unit 16 calculates and returns an IO size (=the number of blocks to be read) on the basis of a requested number of block Ids (hereinafter referred to as a queue length (L)) accumulated in the block IO queue 14, and the IO size (N′) calculated in response to the preceding block read request.

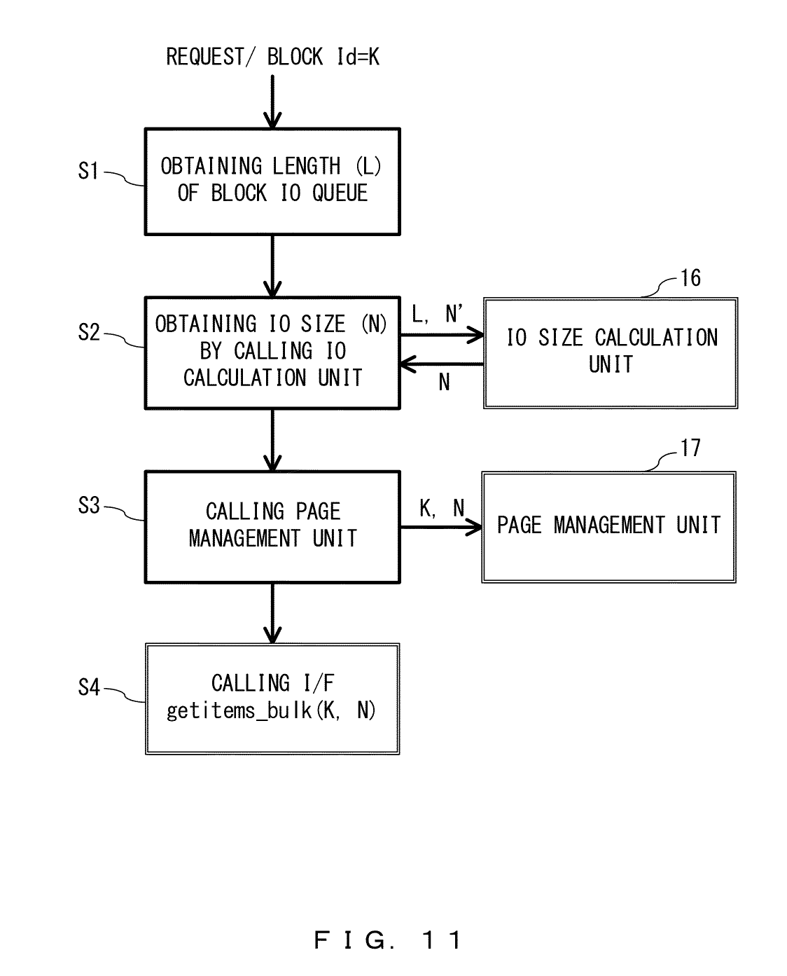

The page management unit 17 holds the page management list 18. The process of the page management unit 17 will be described in detail with reference to FIG. 11. The page management list 18 is used to manage the number of times that each block is referenced, and to manage more recently accessed blocks.

The page management list 18 has a reference counter of each block. When a block read request is issued, the page management unit 17 increments the reference counter of the corresponding block in the page management list 18, and moves the block to the head of the page management list 18.

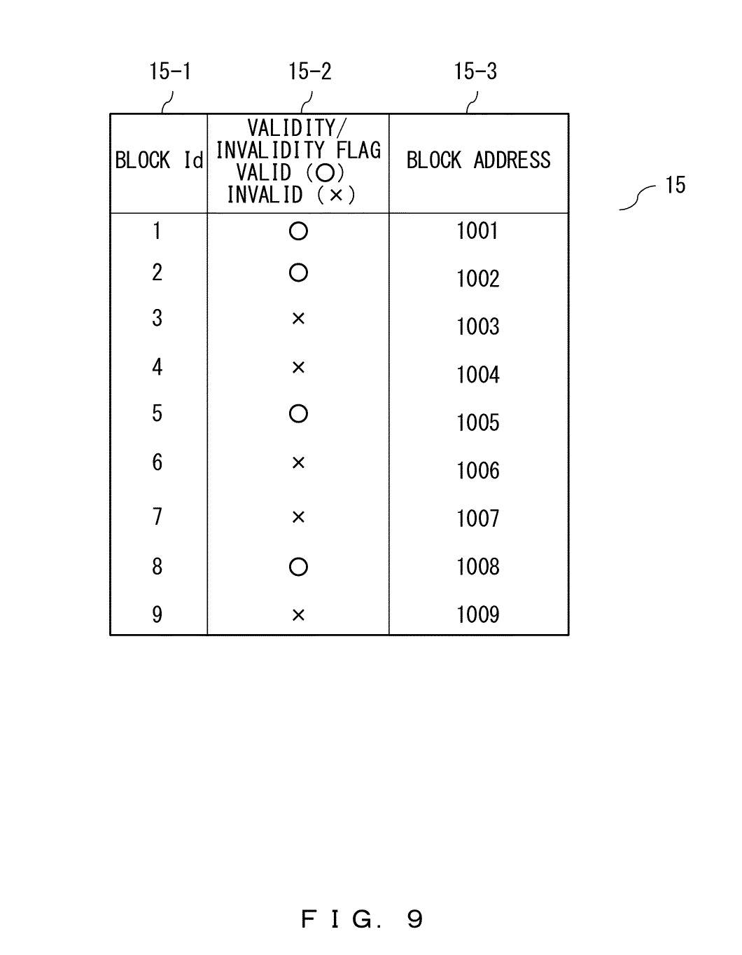

FIG. 9 illustrates one example of the physical layout management information in this embodiment. The physical layout management information 15 includes data entries such as a “block Id” 15-1, a “validity/invalidity flag” 15-2, and a “block address” 15-3.

The “block Id” 15-1 stores a block Id for identifying a block in the disk 20. The “validity/invalidity flag” 15-2 stores flag information indicating whether a block indicated by the block Id is either valid (o) or invalid (x). The “block address” 15-3 stores an address of the block indicated by the block Id in the disk 20.

The I/O execution unit 13 reads block Ids in the order where they are stored in the block IO queue 14. The I/O execution unit 13 references the physical layout management information 15, and obtains block addresses of the block Ids read from the block IO queue 14. The I/O execution unit 13 accesses addresses, indicated by the obtained block addresses, in the disk 20.

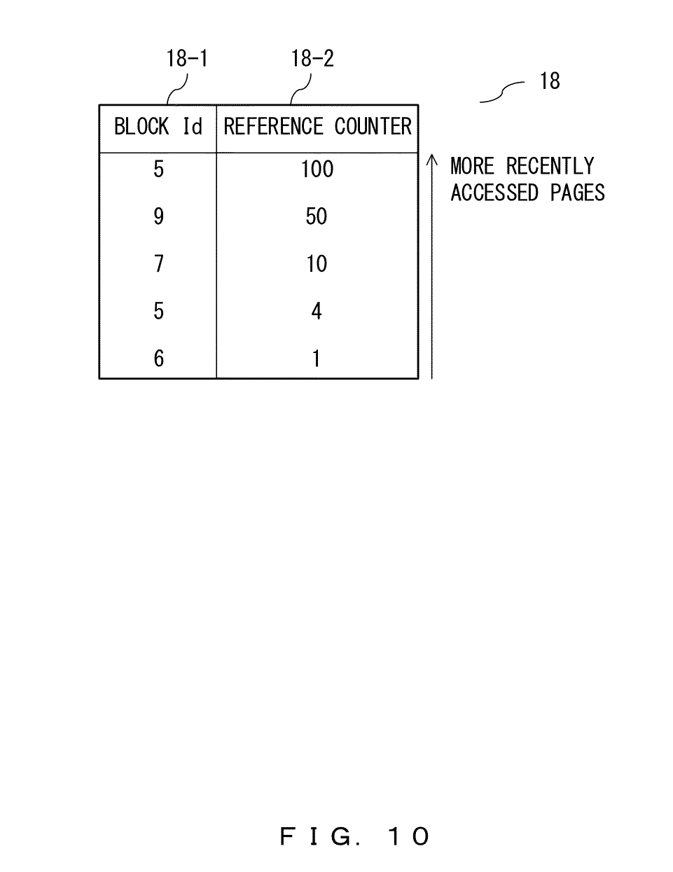

FIG. 10 illustrates an example of the page management list in this embodiment. The page management list 18 includes data entries such as a “block Id” 18-1 and a “reference counter” 18-2. The “block Id” 18-1 stores a block Id for identifying a block corresponding to a page laid out in the memory area 19. The “reference counter” 18-2 stores the number of times that a page corresponding to the block indicated by the block Id is referenced.

In the page management list 18, a more recently accessed page is stored at an address closer to the head of the list.

FIG. 11 illustrates an operational flow of the IO execution unit in this embodiment. After the I/O execution unit 13 reads block Ids (=K) stored in the block IO queue 14 sequentially from the head of the block IO queue 14, it obtains a requested number of block Ids (hereinafter referred to as a queue length (L)) accumulated in the block IO queue 14 (S1).

The I/O execution unit 13 calls the IO size calculation unit 16 to obtain an IO size (the number of blocks to be read) (N) (S2). The IO size calculation unit 16 determines the IO size (N) on the basis of the length (L) of the block IO queue, and the IO size (N′) calculated in response to the preceding block read request. For the queue length (L), a threshold value is preset. An initial value of N is preset to 1. When N exceeds the threshold value, for example, a value obtained by doubling N′ is set as a new N (for example, N is incremented to 1, 2, 4, 8, . . . ). Inversely, when L is smaller than the threshold value, N is set to 1/2 (for example, N is decremented to 8, 4, 2, 1). The minimum and the maximum values are set to 1 and a predetermined value (such as 64), respectively.

The I/O execution unit 13 calls the page management unit 17 (S3). The page management unit 17 writes a page having a low access frequency from the memory area 19 to the disk 20 as occasion demands. When a block is read in a case where the memory area 19 is full, the page management unit 17 initially rewrites pages equivalent to the IO size to the disk 20 among pages held in the memory area 19. The pages to be rewritten are assumed to be those equivalent to the IO size (N pages) sequentially from the lowest-order page in the page management list 18. At that time, the page management unit 17 classifies the pages into a used page and an unused page on the basis of the value of each reference counter. In the page management list 18, a page corresponding a block Id of the reference counter=0 is an “unused page”, whereas a page corresponding to a block Id of the reference counter>0 is a “used page”.

The I/O execution unit 13 calls the IF getitems_bulk(K,N) (S4). The I/O execution unit 13 accesses a block corresponding to a designated block Id(K), and also accesses blocks that are physically laid out in the neighborhood of the designated block Id(K) in the disk 20 in accordance with the IO size (the number of blocks to be read). The IO execution unit 13 returns a valid block among the accessed blocks.

When the I/O execution unit 13 reads blocks, it normally uses the nonvolatile read. However I/O execution unit 13 uses the volatile read when the value of the filling rate becomes smaller than a certain threshold value. Before the I/O execution unit 13 reads blocks, it calculates the filling rate by referencing the physical layout management information 15, and selects either of the volatile read and the nonvolatile read as a read method on the basis of the calculated filling rate. The I/O execution unit 13 invalidates a block in the physical layout management information 15 when the block is deleted in the case where the I/O execution unit 13 selects the volatile read.

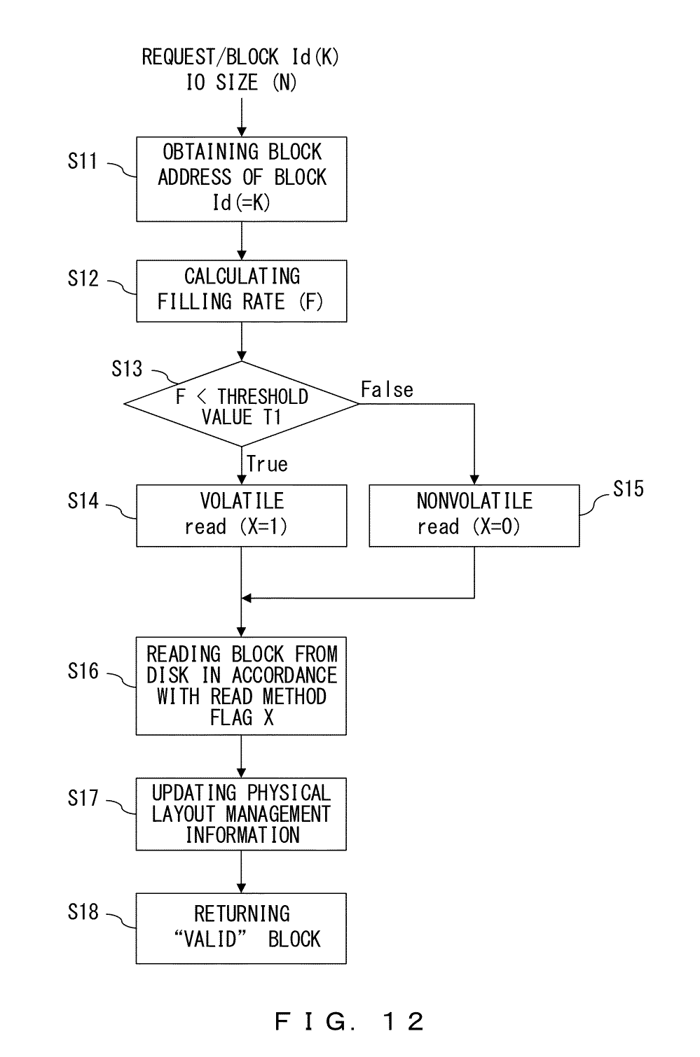

FIG. 12 illustrates an operational flow of the IF getitems_bulk(K,N) in this embodiment. To the called getitems_bulk(K,N), a requested block Id(K) and an IO size (N) are passed as input parameters.

The I/O execution unit 13 obtains a block address of the block Id(=K) from the physical layout management information 15 (S11). For example, when the requested block Id is “1” in FIG. 9, a block address “1001” is obtained from the physical layout management information 15.

The I/O execution unit 13 calculates a filling rate (F) from the physical layout management information 15 (S12). For example, in FIG. 9, there are four blocks read with a prefetch, having block Ids=1 to 4, when the IO size (N)=4. The number of blocks having a validity/invalidity flag that is set to valid (o) among the four read blocks. Therefore, the filling rate is 2/4=50 percent.

The I/O execution unit 13 makes a comparison between the filling rate (F) and a threshold value T1 (S13). The threshold value T1 is preset in a storage unit. When the filling rate (F) is smaller than the threshold value T1, the I/O execution unit 13 selects the volatile read as a read method, and sets a read method flag X to “1” (S14). When the filling rate (F) is equal to or larger than the threshold value T1, the I/O execution unit 13 selects the nonvolatile method as the read method, and sets the read method flag X to “0” (S15).

The I/O execution unit 13 reads blocks having block Ids=K to K+N−1 from the disk 20 by using the read method according to the value set in the read method flag X (S16).

When the read method flag X=“1” (volatile read), the I/O execution unit 13 updates the validity/invalidity flag of the block read in S16 to invalid (x) in the physical layout management information 15 in order to invalidate the read block (S17).

The I/O execution unit 13 returns the valid block read in S16 (S18). Namely, the I/O execution unit 13 returns the block having the validity/invalidity flag that is set to valid (o) in the physical layout management information 15 before the flag is updated in S17 among the blocks read in S16. The I/O execution unit 13 holds the page corresponding to the read valid block in the memory area 19.

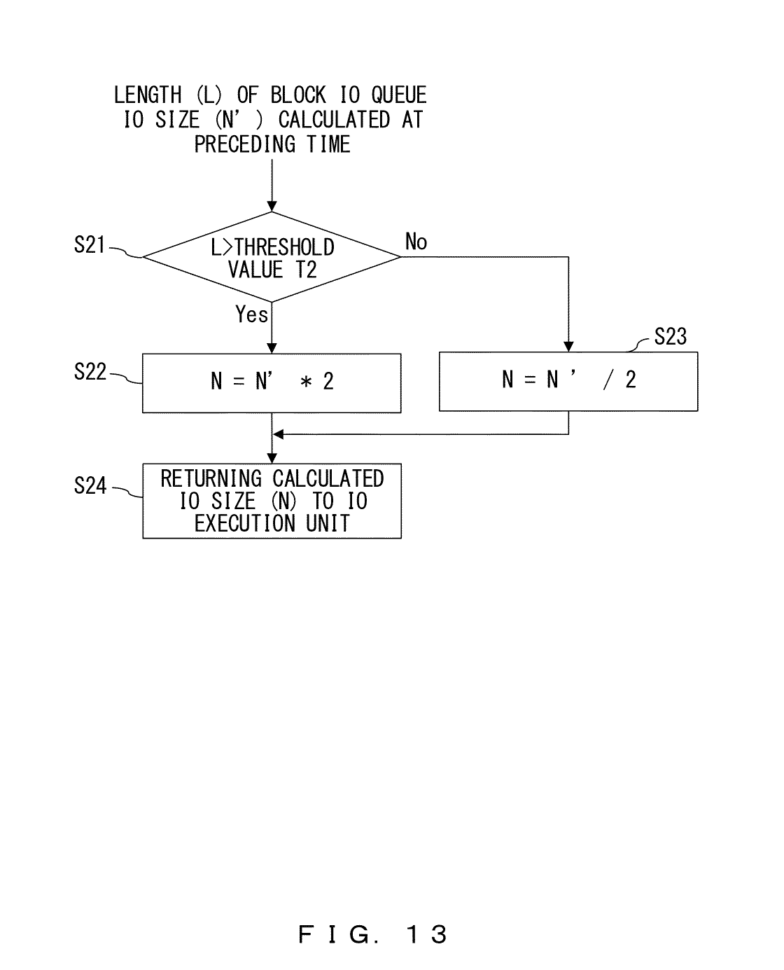

FIG. 13 illustrates an operational flow of the IO size calculation unit in this embodiment. In S2 of FIG. 11, the IO size calculation unit 16 called by the I/O execution unit 13 executes the flow illustrated in FIG. 13. The IO size calculation unit 16 receives the block IO queue length (L) and the IO size (N′) calculated at the preceding time from the I/O execution unit 13 as input parameters.

The IO size calculation unit 16 makes a comparison between the block IO queue length (L) and a threshold value T2 (S21). The threshold value T2 is preset in the storage unit. When the block IO queue length (L) is larger than the threshold value T2, the IO size calculation unit 16 sets N to a value calculated by doubling N′ (S22). Here, the maximum value of N is predetermined. The maximum value of N is assumed to be 64, and is not increased to a value larger than 64.

When the block IO queue length (L) is equal to or smaller than the threshold value T2, the IO size calculation unit 16 sets N to a value calculated by dividing N′ by 2 (S23). Here, the minimum value of N is assumed to be “1”, and is not decreased to a value smaller than “1”.

The IO size calculation unit 16 returns the calculated IO size (N) to the I/O execution unit 13 (S24).

The page management unit 17 and the page management list 18 are described next.

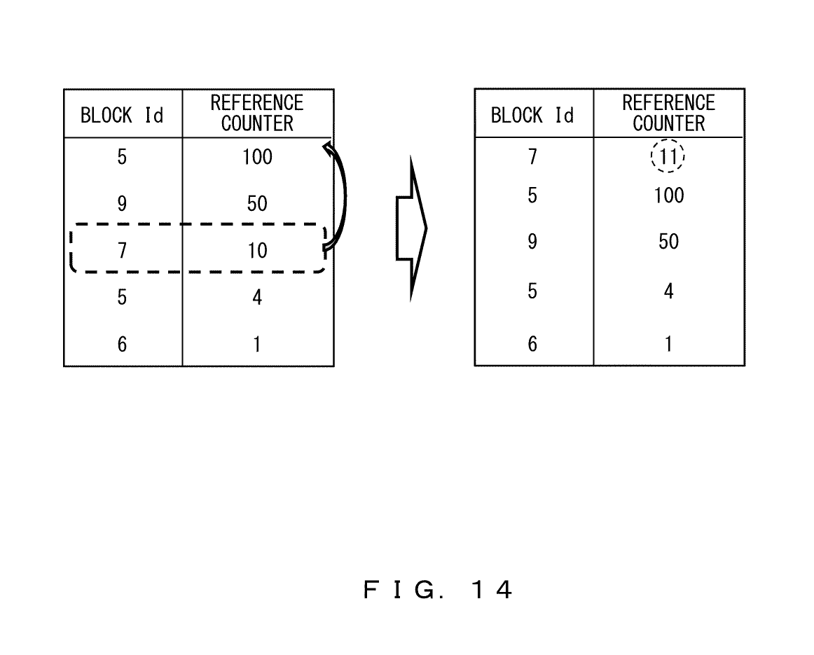

FIG. 14 illustrates an example of an update of the page management list when a block having a block Id (K=7) is requested in this embodiment. When the block having the block Id=7 is requested, the page management unit 17 increments the reference counter of the block Id=7 in the page management list 18, and moves the entry of the block Id=7 to the head of the page management list 18.

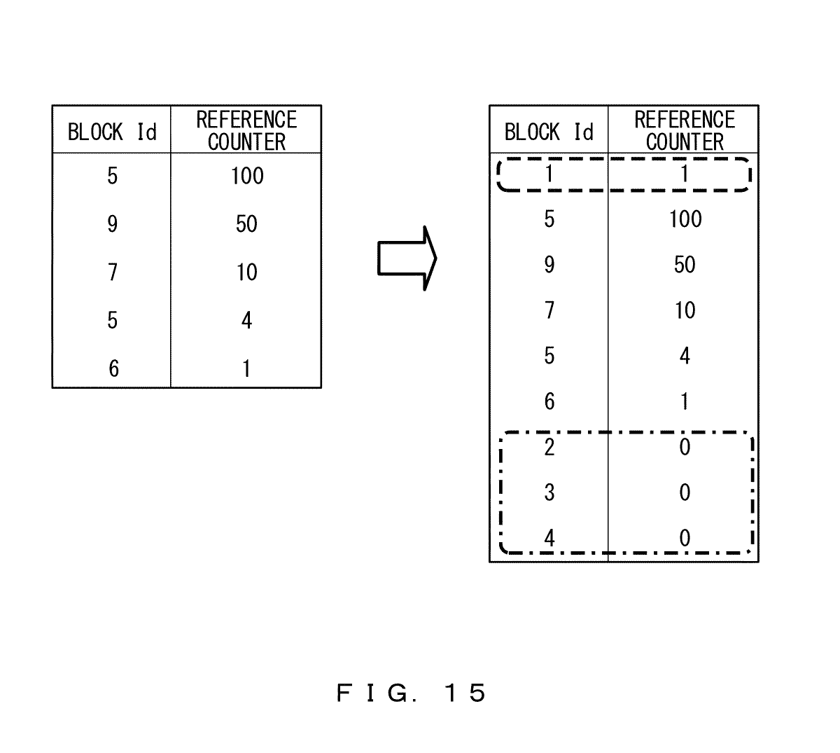

FIG. 15 illustrates an example of an update of the page management list after getitems_bulk(K,N) is called in this embodiment. A case where a block having a block Id (K=1) is requested, and blocks of an IO size N=4, IF getitems_bulk(1, 4), and block Ids=[1, 2, 3, 4] are read, is described with reference to FIG. 15.

The page management unit 17 lays out an entry of the page corresponding to the requested block (block Id=1) at the head of the page management list 18. Moreover, the page management unit 17 lays out entries of the pages corresponding to the blocks (having the block Ids=2, 3, 4) that are not requested at the end of the page management list 18, and sets reference counters of the blocks to “0”.

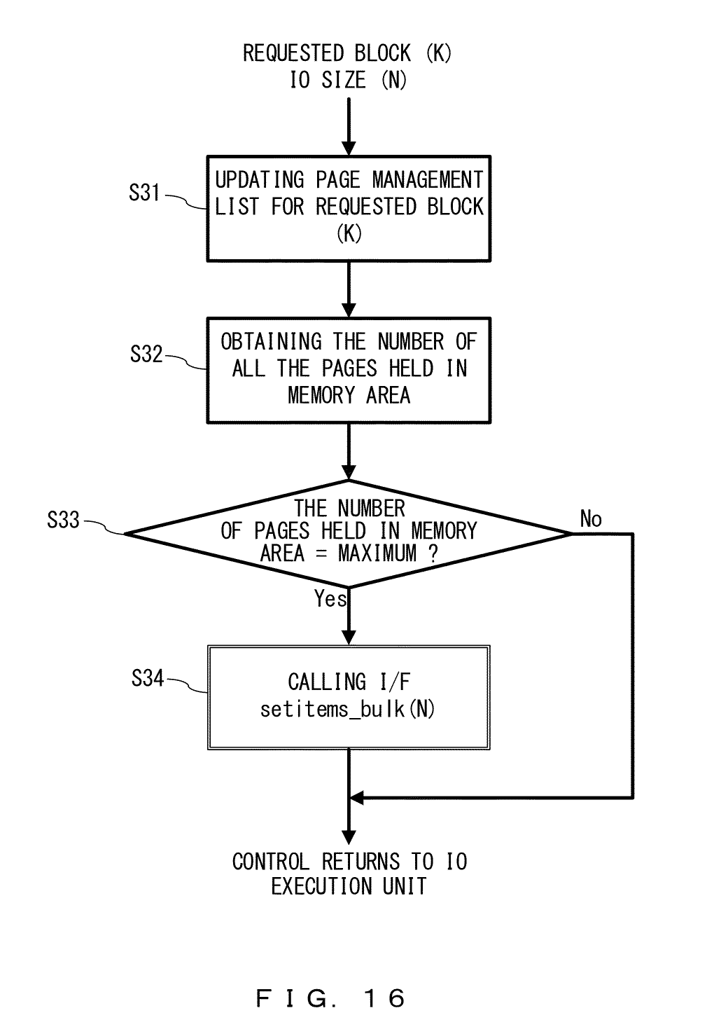

FIG. 16 illustrates an operational flow of the page management unit in this embodiment. In S3 of FIG. 11, the page management unit 17 called by the I/O execution unit 13 executes the flow illustrated in FIG. 16. The page management unit 17 receives, from the I/O execution unit 13, the requested block Id(K) and the IO size (N) as input parameters.

The page management unit 17 updates the page management list 18 for the requested block (K) as described earlier with reference to FIGS. 14 and 15 (S31).

The page management unit 17 obtains the number of all the pages held in the memory area, namely, the number of all the entries registered in the page management list 18 (S32).

When the number of pages obtained in S32 is the maximum number of pages that can be held in the memory area 19 (“YES” in S33), the page management unit 17 executes the following process. Namely, the page management unit 17 calls the IF setitems_bulk (N), and writes pages corresponding to the IO size from the memory area 19 to the disk 20 (S34). Thereafter, the control returns to the IO execution unit 13.

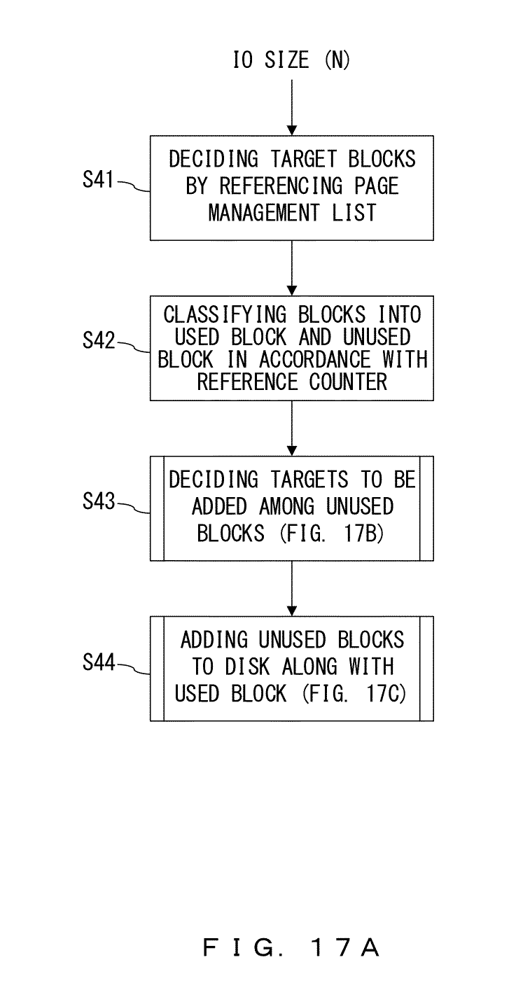

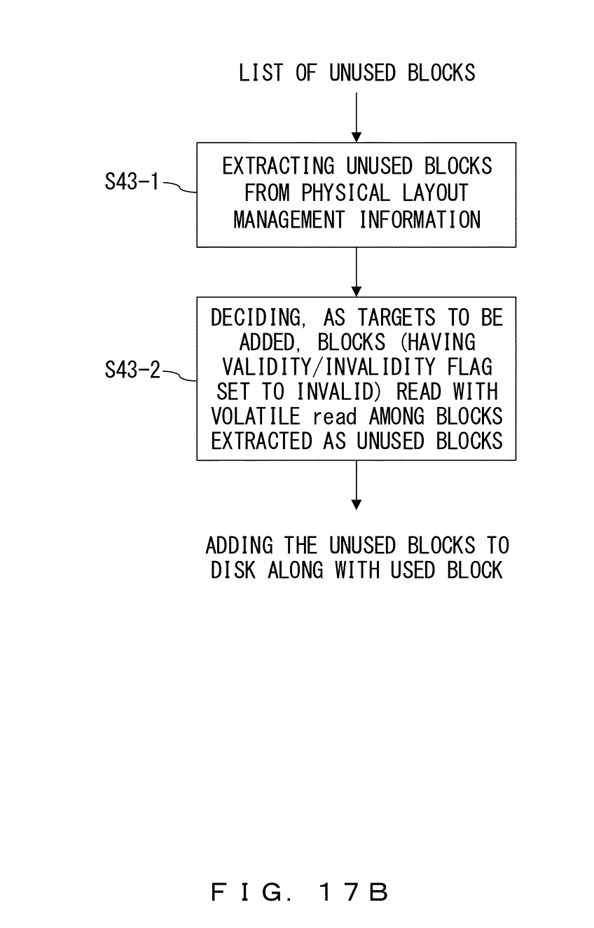

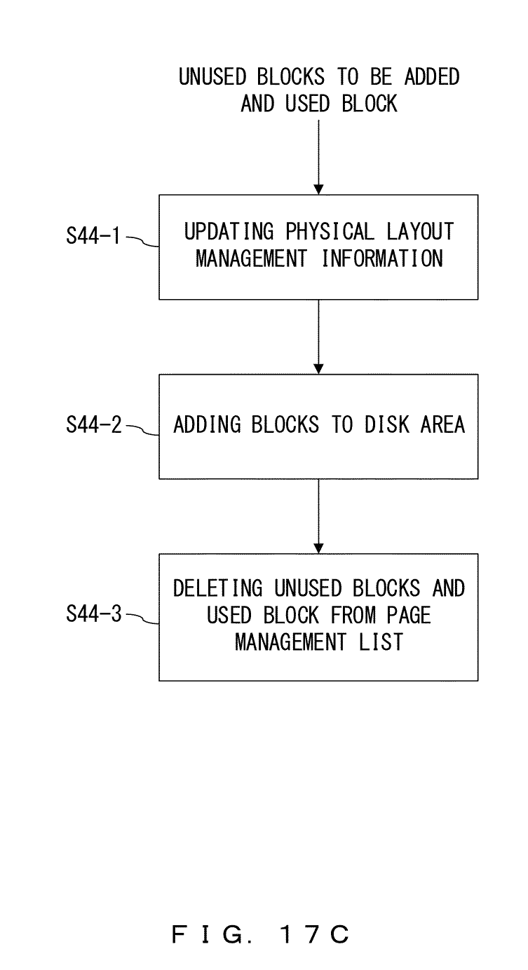

FIGS. 17A to 17C illustrate an operational flow of the IF setitems_bulk(N) in this embodiment. To setitems_bulk(N) called by the page management unit 17, an IO size (N) is transferred as an input parameter.

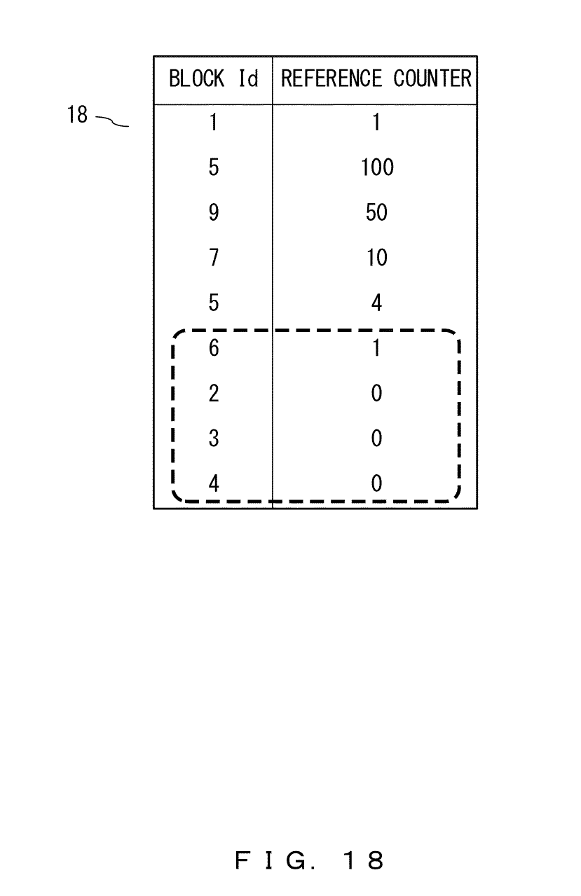

The page management unit 17 determines target blocks on the basis of the IO size (N) by referencing the page management list 18 (S41). Here, the page management unit 17 selects, as target blocks, blocks corresponding to pages equivalent to the IO size (N) sequentially from the end of the page management list 18. For example, in the case of N=4, the blocks corresponding to the pages indicated by the four entries are selected sequentially from the bottom of the page management list 18 as target blocks, as indicated by a portion enclosed with a dashed line in FIG. 18.

The page management unit 17 classifies the pages corresponding to the target blocks selected in S41 into a block (used block) corresponding to a used page and blocks (unused blocks) corresponding to unused pages on the basis of the reference counter in the page management list (S42). In the case of FIG. 18, the used block is a block having a block Id=6, whereas the unused blocks are blocks having block Ids=2, 3, 4.

The page management unit 17 determines blocks to be added among the unused blocks (S43). FIG. 17B illustrates details of the process of S43.

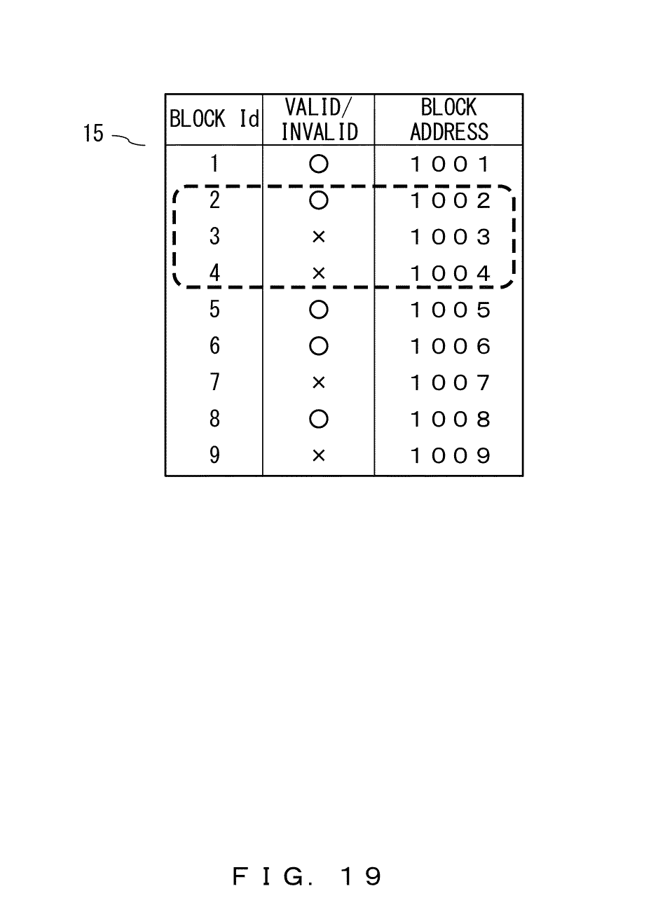

The page management unit 17 extracts entries of the unused blocks classified in S42 from the physical layout management information 15 (S43-1). In the case of the above described example (in the case where the unused blocks are the blocks having block Ids=2, 3, 4), the entries of the blocks having the block Ids=2, 3, 4 are extracted from the physical layout management information 15 as indicated by a portion enclosed with a dashed line in FIG. 19.

The page management unit 17 determines, as targets to be added, blocks read with the volatile read, namely, blocks having a validity/invalidity flag that is set to invalid from among the blocks extracted as the unused blocks in S43-1 (S43-2). Here, the blocks that have the block Ids=3, 4 and a validity/invalidity flag that is set to invalid are recognized as the targets to be added among the blocks that have the block Ids=2, 3, 4 and have been extracted in S43-1 . As will be described later, the unused blocks are added to the disk 20 along with the used block. Return to FIG. 17A.

The page management unit 17 executes a process for adding the unused blocks to the disk 20 along with the used block (S44). FIG. 17C illustrates details of the process of S44.

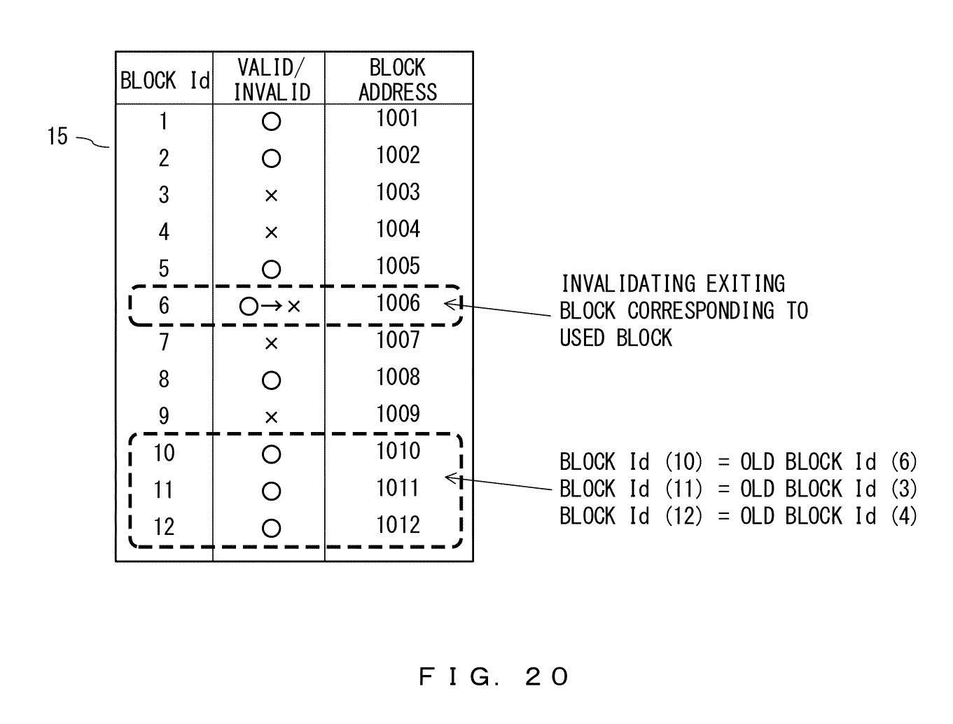

The page management unit 17 updates the physical layout management information 15 on the basis of the used block classified in S42 and the unused blocks to be added that were selected in S43 (S44-1). In the above described example, the used block classified in S42 is the block having the block Id=6. Moreover, the unused blocks to be added that were selected in S43 are the blocks having the block Ids=3, 4. In this case, the page management unil 7 sets the validity/invalidity flag of the used block (block Id=6) to invalid (x) in the physical layout management information 15 as illustrated in FIG. 20 so that the unused block is invalidated.

Then, the page management unit 17 appends the used block classified in S42 and the unused blocks to be added that were selected in S43 to the end of the physical layout management information 15. As illustrated in FIG. 20, the page management unit 17 newly adds the entries of the blocks having the block Ids=10, 11, 12 to the end of the physical layout management information 15 as blocks corresponding to the old block Ids=6, 3, 4. At this time, the validity/invalidity flag of the added entries is set to valid (o).

The page management unit 17 adds the blocks corresponding to the block Ids appended to the physical layout management information 15 in S44-1 to empty areas (or invalidated areas) adjacent to the last area in which valid blocks are laid out in the disk 20 (S44-2). Namely, the page management unit 17 writes m blocks to consecutively empty areas (or invalidated areas) in which m blocks are not stored sequentially from a storage area that is physically positioned last among written storage areas in the disk 20. Here, the m (m: integer) blocks are blocks corresponding to the block Ids appended to the physical layout management information 15 in S44-1.

The page management unit 17 deletes the unused blocks and the used block from the page management list 18 (S44-3).

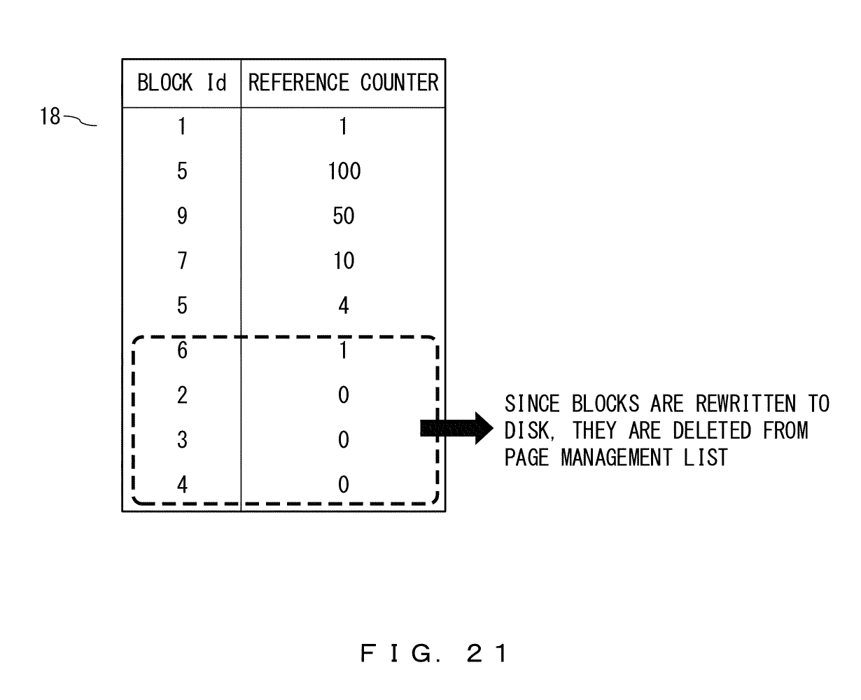

The page management unit 17 deletes the target blocks (the unused blocks and the used block) determined in S41 from the page management list 18. In the case of FIG. 21, four blocks are deleted sequentially from the bottom of the page management list 18.

According to this embodiment, “used blocks” are collectively laid out in a storage area of a disk. Moreover, a plurality of blocks prefetched with the volatile read are deleted from an area of a disk in which the blocks are laid out. Therefore, consecutively empty areas are secured in a physical area. As a result, the number of useless reads performed with a prefetch can be reduced, and the use efficiency of the memory area can be improved. At the same time, a prefetch can be made efficient, and a speeding up can be achieved by efficiently using a memory area.

In this embodiment, when pages are rewritten from the memory area 19 to the disk 20, blocks to be rewritten are added to an empty block (or an invalidated block) adjacent to the last valid block among valid blocks laid out in the disk 20. However, the rewrite of the blocks is not limited to this manner. For example, when an empty area (invalidated area) having a size equal to or larger than that of blocks to be added is present within the disk 20, the blocks may be written sequentially from an area of a valid block immediately preceding the empty area.

As described above, an access control program according to this embodiment causes a computer to execute the following process. The computer reads a block in which data requested to be accessed is laid out, and one or more blocks that are physically laid out in the neighborhood of the block from a storage device in which a storage area is managed in units of blocks. The computer writes the data stored in the blocks read from the storage device to pages in a memory area. If there is no empty page in an available memory area used when a block is read, the computer selects a page in the memory in accordance with a state of an access, and deletes data of the page from the memory or writes the data to the storage device. Namely, the computer creates an empty page. Thereafter, the computer reads the block, and writes the data stored in the read block to the empty page (data replacement within the page; hereinafter referred to as “page replacement”). At that time, the computer invalidates the block from which the data within the page is read, in the storage device in accordance with the state of the access to the selected page. When the computer writes the data within the page to the storage device, it writes the data to consecutively empty areas in the storage device after it invalidates the block from which the data within the page is read, in the storage device.

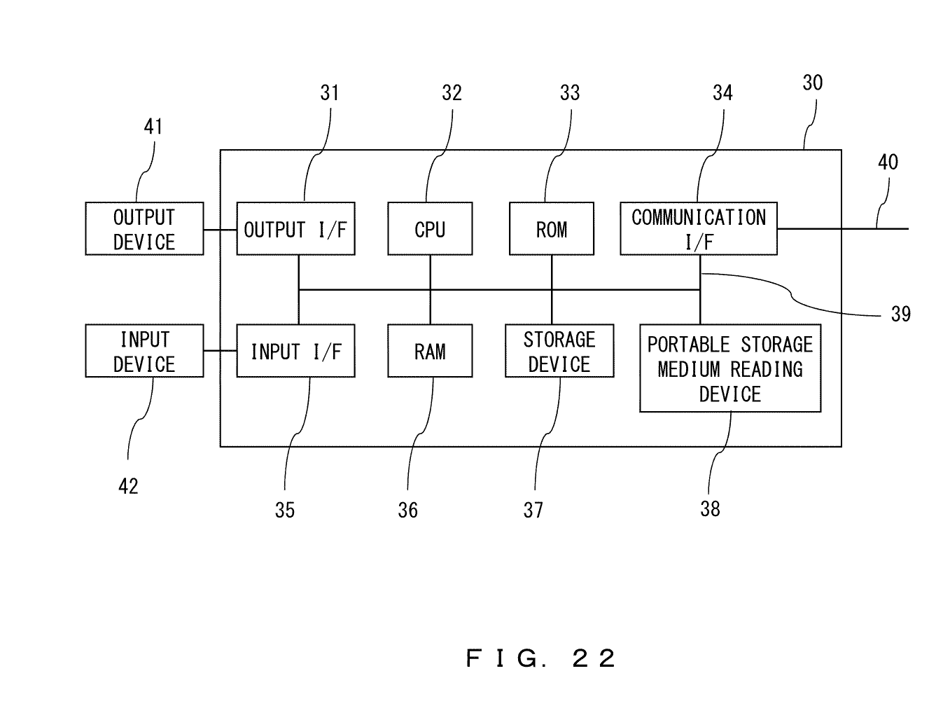

FIG. 22 illustrates an example of a configuration block diagram of a hardware environment of the computer that executes the program according to this embodiment. The computer 30 functions as the server 11. The computer 30 is configured by including a CPU 32, a ROM 33, a RAM 36, a communication I/F 34, a storage device 37, an output I/F 31, an input I/F 35, a reading device 38, a bus 39, an output device 41, and an input device 42.

Here, the CPU stands for a central processing unit. The ROM stands for a read only memory. The RAM stands for a random access memory. The I/F stands for an interface. To the bus 39, the CPU 32, the ROM 33, the RAM 36, the communication I/F 34, the storage device 37, the output I/F 31, the input I/F 35, and the reading device 38 are connected. The reading device 38 is a device that reads a portable recording medium. The output device 41 is connected to the output I/F 31. The input device 42 is connected to the input I/F 35.

As the storage device 37, storage devices in various forms, such as a hard disk, a flash memory, a magnetic disk and the like, are available. In the storage device 37 or the ROM 33, a program for causing the CPU 32 to function as the access control apparatus 1 is stored. The RAM 36 has a memory area for temporarily holding data.

The CPU 32 reads and executes the program that is stored in the storage device 37 or the like and implements the processes referred to in the above described embodiment.

The program that implements the processes referred to in the above described embodiment may be provided from a program provider side, and stored, for example, in the storage device 37 via a communication network 40 and the communication I/F 34. Moreover, the program that implements the processes referred to in the above described embodiment may be stored in a portable storage medium that is marketed and distributed. In this case, this portable storage medium may be set in the reading device 38, the program of the medium may be installed in the storage device 37, and the installed program may be read and executed by the CPU 32. As the portable storage medium, storage media in various forms, such as a CD-ROM, a flexible disk, an optical disk, a magneto-optical disk, an IC card, a USB memory device, and the like, are available. The program stored in such storage media is read by the reading device 38.

Additionally, as the input device 42, a keyboard, a mouse, an electronic camera, a Web camera, a microphone, a scanner, a sensor, a tablet, and the like are available. Moreover, as the output device 41, a display, a printer, a speaker and the like are available. Additionally, the communication network 40 may be a communication network such as the Internet, a LAN, a WAN, a dedicated line network, a wired network, a wireless network or the like.

This embodiment is not limited to the above described one, and can take various configurations or embodiments within a scope that does not depart from the gist of the embodiment.

According to one aspect of the present invention, the use efficiency of read data in a data access using a process for reading data in the neighborhood of requested data along with the requested data from a storage device can be improved.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A non-transitory computer-readable recording medium having stored therein an access control program that causes a computer to execute a process comprising:
reading first consecutive blocks from a storage device in response to an access request for a first data, the first consecutive blocks including a first block, storage areas of the storage device being managed in units of blocks;
loading the first consecutive blocks into a memory area, storage areas of the memory area being managed in units of pages; and
in accordance with a state of an access to a page in the memory area, invalidating a specific block of the storage device that corresponds to a specific page pushed out of the memory area, the specific page being pushed out as a consequence of loading the first consecutive blocks into the memory area, and writing second data included in the specific page to consecutive empty areas of the storage device.

2. The non-transitory computer-readable recording medium according to claim 1, wherein
the invalidating invalidates the specific block of the storage device that corresponds to the specific page accessed in the memory area from among one or more pushed-out pages.

3. The non-transitory computer-readable recording medium according to claim 2, wherein
the reading reads the first consecutive blocks by using one of a first read method for reading the first consecutive blocks from the storage device and loading the first consecutive blocks into the memory area, and a second read method for executing the first read method and invalidating the first consecutive blocks of the storage device; and
the writing writes third data, which is a page not accessed in the memory area and is the pushed-out page that corresponds to the invalidated specific block, to the consecutive empty areas along with the second data, when the second data is the specific page accessed in the memory area.

4. The non-transitory computer-readable recording medium according to claim 3, wherein
the reading selects one of the first read method and the second read method in accordance with a ratio of valid blocks to the first consecutive blocks.

5. An access control apparatus comprising
a processor that executes a process including:
reading first consecutive blocks from a storage device in response to an access request for a first data, the first consecutive blocks including a first block, storage areas of the storage device being managed in units of blocks;
loading the first consecutive blocks into a memory area, storage areas of the memory area being managed in units of pages; and
in accordance with a state of an access to a page in the memory area, invalidating a specific block of the storage device that corresponds to a specific page pushed out of the memory area, the specific page being pushed out as a consequence of loading the first consecutive blocks into the memory area, and writing second data included in the specific page to consecutive empty areas of the storage device.

6. The access control apparatus according to claim 5, wherein
the invalidating invalidates the specific block of the storage device that corresponds to the specific page accessed in the memory area from among the one or more pushed-out pages.

7. The access control apparatus according to claim 6, wherein
the reading reads the first consecutive blocks by using one of a first read method for reading the first consecutive blocks from the storage device and loading the first consecutive blocks into the memory area and a second read method for executing the first read method and invalidating the first consecutive blocks in the storage device; and
the writing writes third data, which is a page not accessed in the memory area and is the pushed-out page that corresponds to the invalidated specific block, to the consecutive empty areas along with the second data, when the second data is the specific page accessed in the memory area.

8. The access control apparatus according to claim 7, wherein
the reading selects one of the first read method and the second read method in accordance with a ratio of valid blocks to the first consecutive blocks.

9. An access control method for performing an access control, the access control method comprising:
reading first consecutive blocks from a storage device in response to an access request for a first data, the first consecutive blocks including a first block, storage areas of the storage device being managed in units of blocks by using a computer;
loading the first consecutive blocks into a memory area, storage areas of the memory area being managed in units of pages by using the computer; and
in accordance with a state of an access to a page in the memory area, invalidating a specific block of the storage device that corresponds to a specific page pushed out of the memory area, the specific page being pushed out as a consequence of loading the first consecutive blocks into the memory area, and writing second data included in the specific page to consecutive empty areas of the storage device by using the computer.

10. The access control method according to claim 9, wherein
the invalidating invalidates the specific block of the storage device that corresponds to the specific page accessed in the memory area from among one or more pushed-out pages.

11. The access control method according to claim 10, wherein
the reading reads the first consecutive blocks by using one of a first read method for reading the first consecutive blocks from the storage device and loading the first consecutive blocks into the memory area, and a second read method for executing the first read method and invalidating the first consecutive blocks of the storage device; and
the writing writes third data, which is a page not accessed in the memory area and is the pushed-out pages that corresponds to the invalidated specific block, to the consecutive empty areas along with the second data, when the second data is the specific page accessed in the memory area.

12. The access control method according to claim 11, wherein
the reading selects one of the first read method and the second read method in accordance with a ratio of valid blocks to the first consecutive blocks.
